(19) United States
(12) Patent Application Publication
(10) Pub. No.: US 2004/0097307 A1
(43) Pub. Date: May 20, 2004

(54) Drive transmission apparatus

(76) Inventors: Graeme Stafford Murray, Velddrif (ZA); Werner Vogler, Port Owen (ZA)

Correspondence Address: STITES & HARBISON PLLC, 1199 NORTH FAIRFAX STREET, SUITE 900, ALEXANDRIA, VA, 22314, US

(21) Appl. No.: 10/450,241

(22) PCT Filed: Dec. 11, 2001
(86) PCT No.: PCT/ZA01/00199

(30) Foreign Application Priority Data
Dec. 12, 2000 (ZA) 00/4656

(51) Int. Cl. F16H 55/30; F16H 59/00

(52) U.S. Cl. 474/47; 474/69; 474/70

(57) ABSTRACT

A drive transmission apparatus is disclosed in which a driven shaft (18) carries two freely rotatable gear wheels (52) which are in mesh with gear wheels (50). The gear wheels (50) are fast in rotation with threaded spindles (32) which extend radially with respect to the shaft (18). Each spindle (32) passes through a tapped bore in a block (38). Each block (38) carries a sprocket (36). There are one-way clutches between the sprockets (36) and blocks (38). When viewed from the side the axes of the sprockets (36) are located on the circumference of a circle the size of which changes when the spindles (32) are rotated to drive the blocks (38) and hence the sprockets (36) radially inwardly or radially outwardly. A chain (72) is trained around the sprockets (36).

### FIELD OF THE INVENTION

THIS INVENTION relates to drive transmission apparatus.

More particularly, the invention relates to drive transmission apparatus of the kind comprising a first rotatable member, a second rotatable member, and an endless flexible element extending between the rotatable members for transmitting drive between the rotatable members.

Drive transmission apparatus of this kind is, for example, used in bicycles to transmit drive from the pedals to the rear wheel of the bicycle. In this event the first and second rotatable members are each in the form of a sprocket, and the flexible element is in the form of a chain.

Cyclists produce their most efficient power and torque at a particular pedalling speed or cadence. The optimum cadence varies from person to person. It is desirable that this cadence should be maintained, irrespective of external influences such as road gradient, wind resistance, and so on. This applies equally to pedal pressure, which should ideally remain constant. To achieve this requires the drive transmission ratio between the pedals and the rear wheel to be variable.

Presently available variable transmission ratio chain drives are derailleur and gear-based drives. In neither of these is it possible to change the drive transmission ratio in a stepless or infinitely variable manner. As a consequence, a rider is able to change the drive transmission ratio to one that usually only approximates the one that is best for the conditions prevailing at any particular time.

In the derailleur type of chain drive a variable ratio is achieved by employing a multiplicity of sprockets and by providing a mechanism that is able to derail the chain from one sprocket and move it to another. A limited number of discrete transmission ratios are available, and the complexity of the apparatus increases according to the number of transmission ratios that are required. Derailleurs are prone to mechanical failure and their operation is all but elegant.

Chain drives that have a gear-based variable transmission ratio suffer from a weight problem, and have lost much of their earlier popularity to the derailleur type of chain drive.

There is, therefore, a need for a drive transmission apparatus of the kind in question, in which the drive transmission ratio can be varied in a stepless, infinitely variable manner, and is reliable and easy to operate.

Inventors have in the past attempted to devise a usable form of stepless transmission apparatus and the following are examples of such prior proposals:

United States Specifications

3995508B

4129044B

United Kingdom Specifications

2062142B

2135743B

22797111B

PCT Specifications

WO79/00522

WO80/02129

WO83/02925

WO83/01424

WO87/04681

WO96/03599

European Specification

0 246 803

Applicant is not aware that any infinitely variable drive transmission apparatus has ever been commercially successful in respect of cycles. Many forms of stepless transmission apparatus are used in power driven vehicles and static industrial installations. However, these involve power losses in the transmission apparatus of a magnitude that makes them unacceptable for cycles which are manually powered by the cyclist.

### BRIEF DESCRIPTION OF THE INVENTION

According to the present invention there is provided drive transmission apparatus comprising a first rotatable member, a second rotatable member and an endless flexible element extending around said members for transmitting drive between said members, said first rotatable member including a carrier, a plurality of drive transmission elements and a plurality of mounting elements on which the drive transmission elements are mounted, there being means for displacing said drive transmission elements and said mounting elements on the carrier with respect to said axis of rotation of said first rotatable member to change the effective size of the first rotatable member and thus vary the transmission ratio, said flexible element being trained around said drive transmission elements and said drive transmission elements being displaceable with respect to said mounting elements about axes parallel to said axis of rotation to permit the drive transmission elements to move relatively to one another circumferentially during ratio changing thereby to compensate for the change in circumferential distance between said drive transmission elements which occurs during ratio changing, and one way clutch means between the mounting elements and the drive transmission elements which clutch means allow relative circumferential movement of the drive transmission elements to occur whilst still permitting drive to be transmitted through the mounting elements and drive transmission elements, characterized in that said means for displacing the mounting elements and the drive transmission elements comprises a plurality of threaded spindles extending outwards from said axis of rotation, and means for rotating said spindles so that said mounting elements and the drive transmission elements move inwardly or outwardly along the spindles when the spindles are rotated.

In the preferred form said means for rotating said spindles comprises a spindle drive gear fast with each spindle and a gear train for rotating said spindle drive gears during ratio changing. In this form the gear train can comprise a pair of bevel gears with which said spindle drive gears are in mesh, the spindle drive gears and bevel gears normally rotating as a unit and there being means for selectively retarding rotation of one or other of said bevel gears thereby to cause said spindle drive gears and the retarded bevel gear to rotate with respect to one another.

To obtain a desirable mechanical advantage each spindle drive gear can have fewer teeth than the bevel gears whereby one rotation of the bevel gear causes more than one rotation of each spindle drive gear.

To eliminate any slippage said flexible element can be a chain or toothed belt and each of said drive elements can be a toothed cog, there being a one way clutch between each cog and the respective mounting element.

To minimize off-axial loading on the spindles each mounting element can be replaced by a pair of parallel spindles, the drive transmission element carried by each mounting element being mounted on it midway between said spindles.

In a specific form of apparatus each of the threaded spindles has, at its radially inner end, a first gear wheel, the first rotatable member further comprising a pair of second gear wheels, the second gear wheels being arranged on opposite sides of the first rotatable element and each of the second gear wheels meshing with each of the first gear wheels, means being provided for selectively retarding rotation of either the one or the other said second gear wheels with respect to the first rotatable member.

### BRIEF DESCRIPTION OF THE DRAWINGS

The invention will now be described in more detail, by way of example, with reference to the accompanying drawings.

In the drawings:

FIG. 1 is a diagrammatic side view of drive transmission apparatus in accordance with the invention;

FIG. 2 is a section on II-II in FIG. 1;

FIG. 3 is a pictorial view, from the left, of a bicycle incorporating the apparatus of FIGS. 1 and 2;

FIG. 4 is a pictorial view of the bicycle of FIG. 3, from the right;

FIG. 5 is a close-up pictorial view from the right, of a front part of the apparatus;

FIG. 6 is a close-up pictorial view from above, of the front part of the apparatus;

FIG. 7 is a close-up pictorial view from the left, of the front part of the apparatus; and

FIG. 8 is an “exploded” diagrammatic view of part of a further drive transmission apparatus in accordance with the present invention.

### DETAILED DESCRIPTION OF THE DRAWINGS

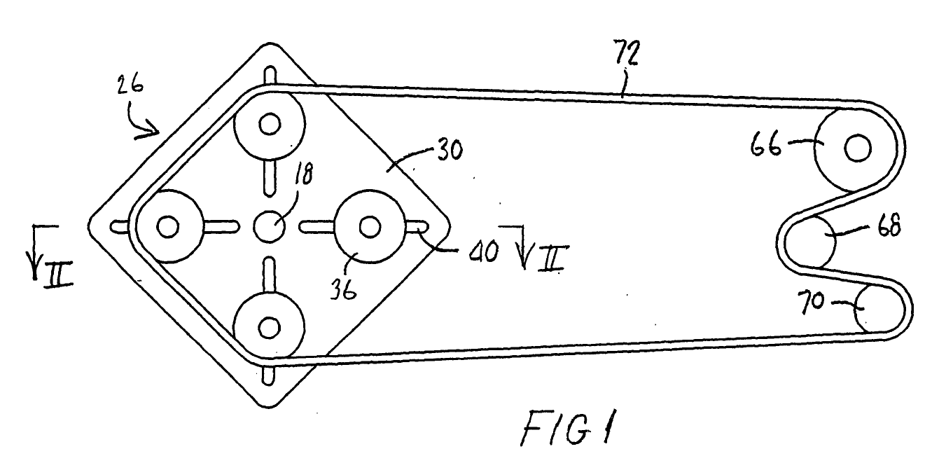

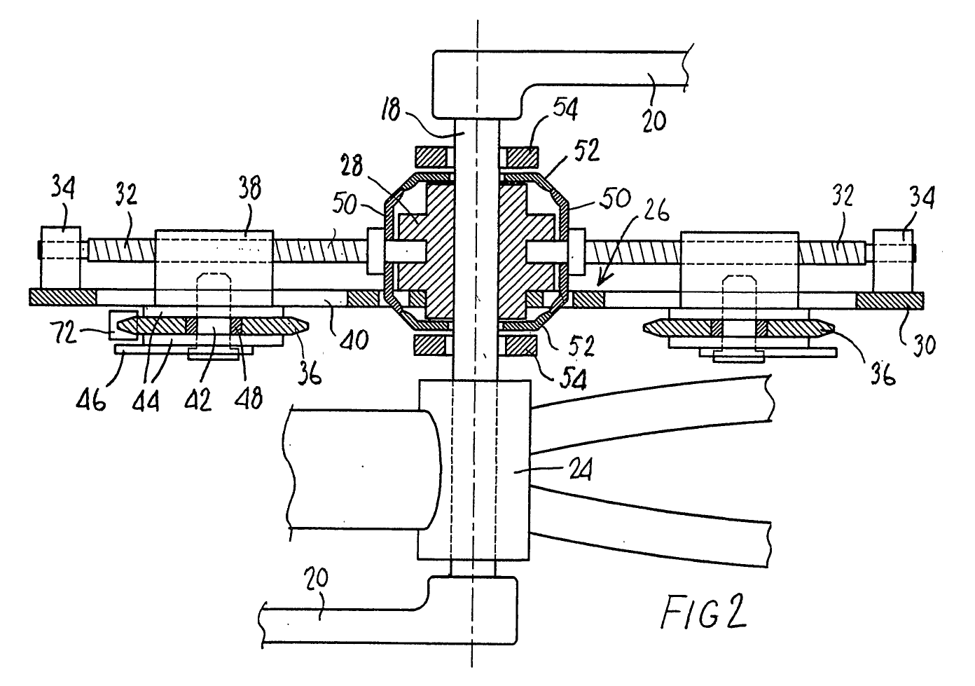

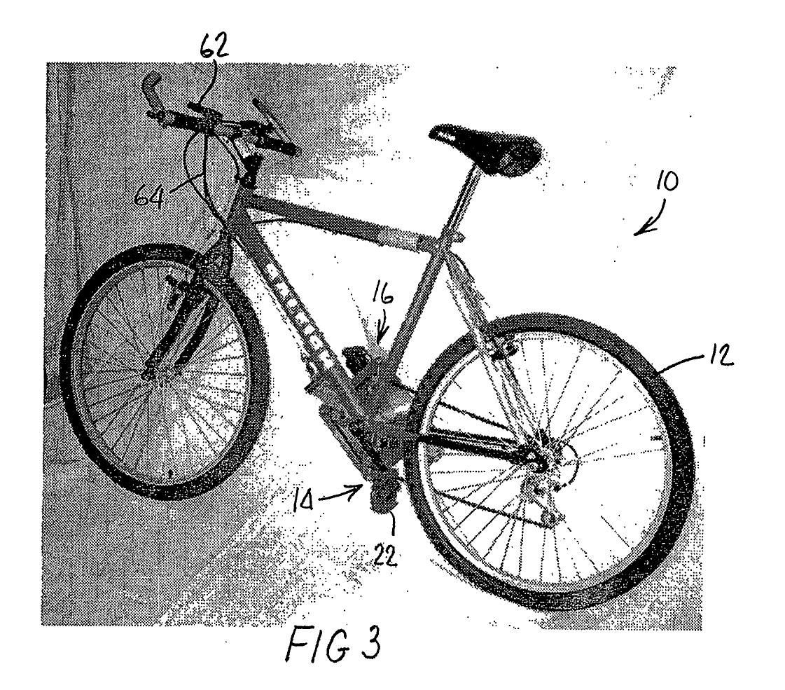

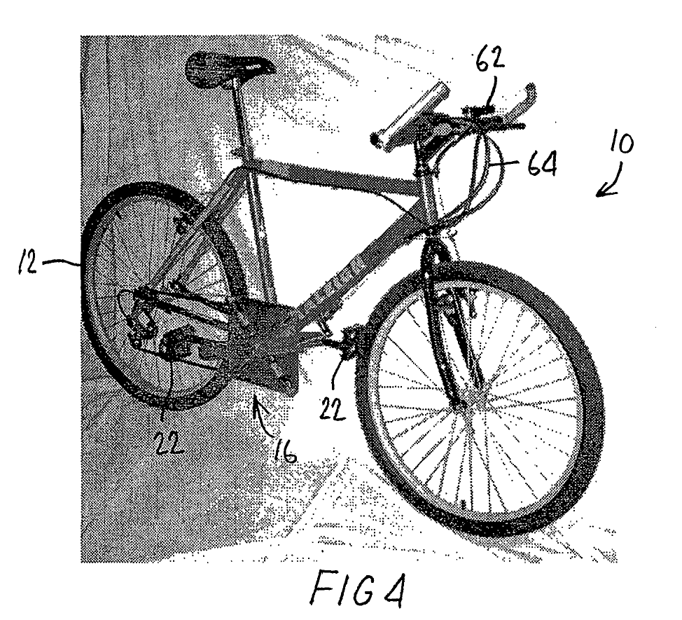

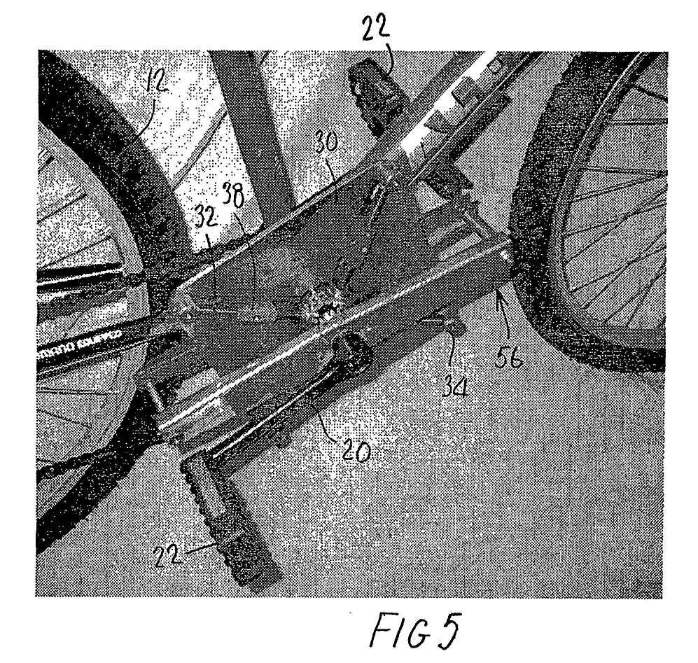

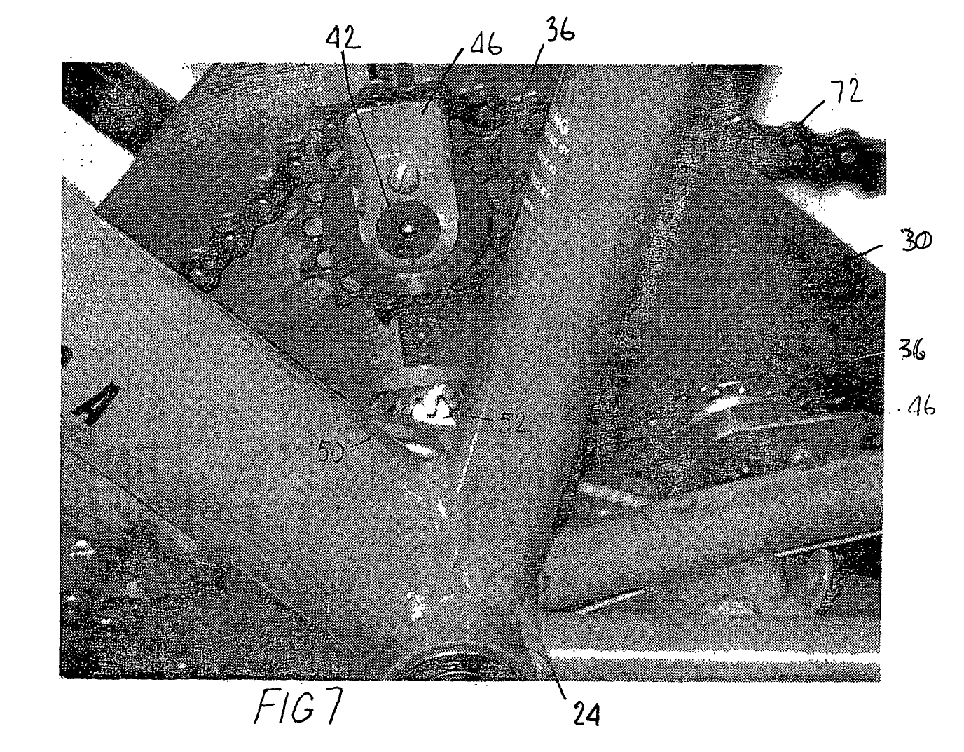

Referring now to FIGS. 1 to 7 of the drawings in more detail, reference numeral 10 generally indicates a bicycle which comprises a rear wheel 12, a crank assembly 14, and drive transmission apparatus 16 for transmitting pedal power from the crank assembly to the rear wheel.

The crank assembly 14 comprises a crank shaft 18, a pair of crank arms 20 at opposite ends of the crank shaft, and a pedal 22 at the end of each crank arm. The crank shaft 18 is mounted via bearings in a crank hub 24, the crank hub forming an integral part of the bicycle frame.

The apparatus 16 comprises a carrier 26 which is mounted on the crank shaft 18 on one side of the crank hub 24. The carrier 26 comprises a boss 28 which is fast with the crank shaft 18, and a generally square carrier plate 30 which is fast with the boss 28. The carrier 26 thus always rotates with the crank shaft 18.

The carrier 26 supports four circumferentially spaced, radially extending, threaded spindles 32. The inner end of each spindle 32 is journalled in the boss 28, and the outer end thereof is journalled in a post 34 which is fixed to the outer periphery of the plate 30.

Each spindle 32 carries a drive transmission element in the from of a sprocket 36, each sprocket 36 being mounted on the associated spindle via a mounting element in the form of a block 38. Each block 38 has a threaded bore therein with which one of the spindles 32 engages and is guided by a radially extending slot 40 in the plate 30. The threaded part of each spindle 32 serves as a lead screw whereby, upon rotation of the spindles, the blocks 38, and thus also the sprockets 36, are displaced radially inwardly or outwardly, depending on the direction of rotation of the spindles.

The sprocket 36 is rotatable on a pin 42 and is located axially between two discs 44. The pin 42 and the discs 44 are fast with the block 38. The disc 44 which is remote from the spindle 32 has a radially protruding guard plate 46 fixed thereto.

Between the sprocket 36 and the pin 42 there is a sprag clutch 48. This enables the sprocket to rotate freely in one direction with respect to the plate 30, but prevents the sprocket from rotating in the opposite direction.

Near the inner end of each of the spindles 32 there is a gear wheel 50, each gear wheel 50 being fast with the respective spindle 32.

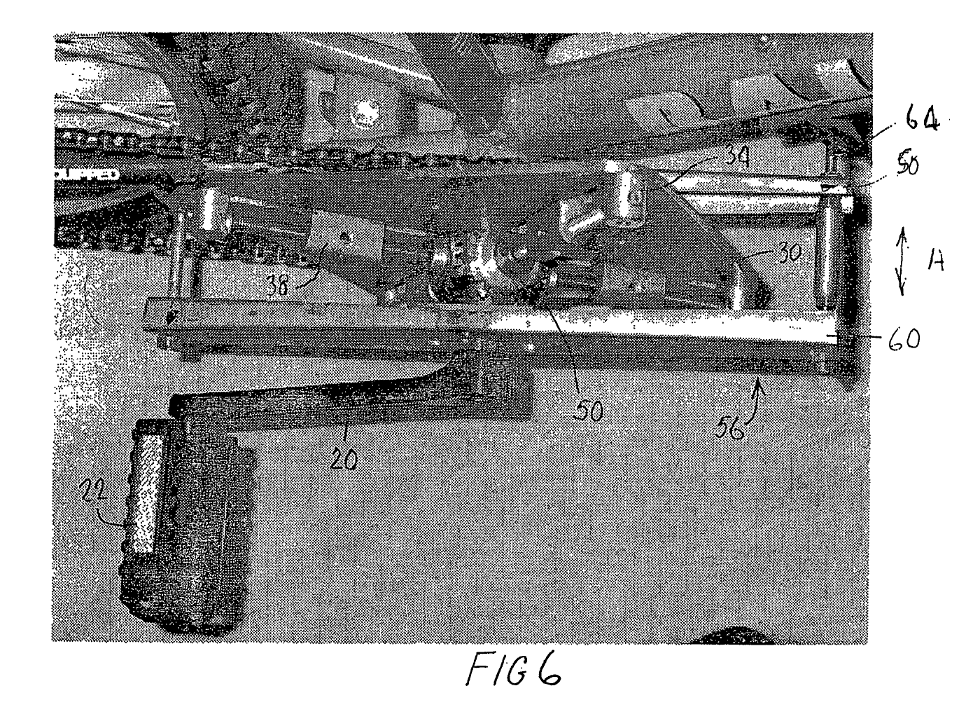

On the crank shaft 18, on each opposite side of the boss 28, there is a gear wheel 52. The two gear wheels 52 are freely rotatable on the crank shaft 18, and each of them meshes with each of the four gear wheels 50. On the outside of each of the two gear wheels 52 there is an annular brake pad 54 which can move towards or away from the corresponding gear wheel 52. The two brake pads 54 are mounted on a structure 56 which comprises a pair of arms 58 and 60. The rear end of each of the arms 58 and 60 is mounted on the bicycle frame in such a manner that each of the arms is pivotally displaceable with respect to the frame about a vertical pivot axis. Thus, the front ends of the arms 58 and 60 can be displaced in the direction of arrows A (FIG. 6). One brake pad 54 is mounted on the arm 58 and the other brake pad 54 is mounted on the arm 60. Movement of the arms 58 and 60 can be effected by means of a lever 62 which is mounted on the handlebars of the bicycle, and is coupled to the structure 56 via a Bowden cable 64. Normally, the two gear wheels 52 both rotate with the shaft 18. However, when the structure 56 is displaced in one direction, the one brake pad 54 is pressed onto the one gear wheel 52, tending to retard it, whereas the other brake pad is drawn away from the other gear wheel 52, freeing it for rotation with respect to the structure 56 and with respect to the crank shaft 18.

The apparatus 16 further comprises a rear sprocket 66 which is fixed to the rear wheel 12, and a pair of jockey sprockets 68 and 70. Finally, there is an endless chain 72 which is trained around the sprockets 36 and 66 and around the jockey sprockets 68 and 70, as can best be seen in FIG. 1. The jockey sprockets 68 and 70 are provided to maintain tension in the chain 72. It will be understood that a single jockey sprocket can be provided to maintain tension in the chain. The guard plates 46 adjacent the sprockets 36 serve to prevent derailment of the chain from the sprockets 36.

The sprockets 36 constitute a plurality of drive transmission elements and the blocks 38 a plurality of mounting elements on which the drive transmission elements are mounted. The spindles 32, gear wheels 50 and 52 and brake pads 54 constitute means for displacing said drive transmission elements and said mounting elements on the carrier 26 with respect to said axis of rotation of rotatable member to change the effective size of the first rotatable member and thus vary the transmission ratio. The cogs 36 are displaceable with respect to the blocks 38 about the axes of the clutches which axes are parallel to said axis of rotation to permit the cogs to move relatively to one another circumferentially during ratio changing thereby to compensate for the change in circumferential distance between the cogs which occurs during ratio changing. The clutches between the blocks 38 and the cogs allow relative circumferential movement of the cogs to occur whilst still permitting drive to be transmitted through the blocks and cogs.

In operation, when pedalling the bicycle to move forward, the carrier 26 rotates in an anti-clockwise direction, as viewed in FIG. 1. The arrangement of the sprag clutches 48 is such that the sprockets 36 are each free to rotate in an anti-clockwise direction with respect to the plate 30 but cannot rotate in a clockwise direction with respect to the plate. Thus, when pedalling forwards, the sprockets 36 are locked against rotation, and drive is transmitted by the chain 72 from the crank assembly 14 to the rear sprocket 66 and thus to the rear wheel 12. The drive transmission ratio will depend on the radial position of the sprockets 36 with respect to the plate 30, and this can be varied in a stepless manner.

During normal operation, the lever 62 is in a neutral position, in which event any friction that there is between one of the two brake pads 54 and the corresponding gear wheel 52 is equal to that between the other brake pad 54 and the corresponding gear wheel 52. Under these conditions the two gear wheels 52 are constrained both to rotate with the crank shaft 18, and the spindles 32 therefore remain stationery with respect to the plate 30. As a consequence, the sprockets 36 remain in a fixed radial position.

When the lever 62 is operated to displace the structure 56 in one direction, however, the friction between one of the brake pads 54 and the corresponding gear wheel 52 increases, and that between the other brake pad 54 and the corresponding gear wheel 52 decreases. As a consequence, the spindles 32 start to rotate with respect to the plate 30. In so doing, the blocks 38, and hence the sprockets 36, are displaced radially outwardly or radially inwardly, depending on the direction of rotation of the spindles 32. If the sprockets 36 move radially outwardly, the drive transmission ratio increases whereas, if the sprockets 36 move radially inwardly, the drive transmission ratio decreases. Once the desired drive transmission ratio has been achieved, the lever 62 is again returned to its neutral position.

It is to be noted that the increase or decrease in drive transmission ratio is stepless, and can be varied to any value between limits that are determined by the extent to which the sprockets 36 can move radially inwardly and outwardly.

Whilst the radial distance of the chain 72 from the axis of rotation of the crank shaft 18 is greater at the sprockets 36 than at points between adjacent sprockets, it has been found that the transmission of rotation from the crank assembly 14 to the rear wheel 12 is surprisingly smooth.

It is to be understood that other means may be provided for moving the sprockets 36 radially inwardly or outwardly, and the invention is therefore not limited to the particular mechanism illustrated in the drawings. For example, radial displacement of the sprockets 36 could be effected by means of a cam mechanism, or by means of geared, electronically controlled motors.

The apparatus lends itself to automatic operation. For example, means may be provided for sensing input values such as road speed, pedal pressure, and cadence, and in response thereto automatically to adjust the drive transmission ratio. The heart rate of the rider could, for example, be used as an input value, thereby enabling the rider's effort automatically to be limited to a safe level.

It is further to be understood that, whilst the invention finds particular application in the field of chain and sprocket drives for bicycles, it can have many other applications.

Whilst it is preferred that the bores in the blocks 38 be tapped bores, it will be understood that any arrangement in which rotation of the spindles results in linear movement of the blocks can be used. Where threading is used, it can be single or multi-start.

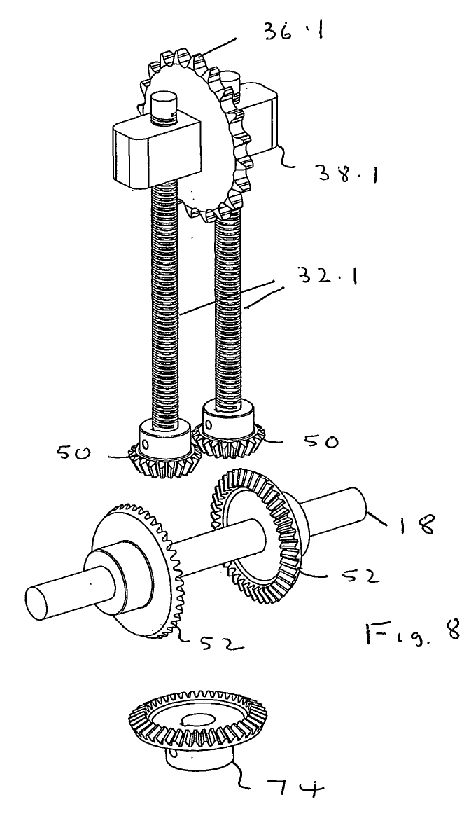

In the embodiment of FIG. 8 each single spindle 32 is replaced by a pair of parallel spindles 32.1. Each spindle 32.1 passes through a threaded bore in a block 38.1. The sprocket 36.1 about which the chain 72 (not shown in FIG. 8) is entrained is mounted on the blocks 38.1 via a one way clutch equivalent to the clutch 48. It will be understood that in FIG. 1 the force applied to each sprocket 36 by the chain 72 is along a line spaced from the axis of the associated spindle 32. There is thus a tendency to pull the blocks 38 skew on their spindles 32. In FIG. 8 the line of force is between the spindles 32.1 and thus the arrangement is symmetrical.

The freely rotatable gear wheels 52 on the crank shaft 18 are shown as are the two gearwheels 50 which rotate the spindles 32.1. The remaining spindles 32.1 and gear wheels 50 have not been shown.

The gear 74 ensures that the gear wheels 52 rotate in opposite directions when either is braked thereby ensuring that the spindles 32.1 rotate in the same direction as one another.

1. Drive transmission apparatus comprising a first rotatable member, a second rotatable member and an endless flexible element extending around said members for transmitting drive between said members, said first rotatable member including a carrier, a plurality of drive transmission elements and a plurality of mounting elements on which the drive transmission elements are mounted, there being means for displacing said drive transmission elements and said mounting elements on the carrier with respect to said axis of rotation of said first rotatable member to change the effective size of the first rotatable member and thus vary the transmission ratio, said flexible element being trained around said drive transmission elements and said drive transmission elements being displaceable with respect to said mounting elements about axes parallel to said axis of rotation to permit the drive transmission elements to move relatively to one another circumferentially during ratio changing thereby to compensate for the change in circumferential distance between said drive transmission elements which occurs during ratio changing, and one way clutch means between the mounting elements and the drive transmission elements which clutch means allow relative circumferential movement of the drive transmission elements to occur whilst still permitting drive to be transmitted through the mounting elements and drive transmission elements, characterized in that said means for displacing the mounting elements and the drive transmission elements comprises a plurality of threaded spindles extending outwards from said axis of rotation, and means for rotating said spindles so that said mounting elements and the drive transmission elements move inwardly or outwardly along the spindles when the spindles are rotated.

2. Drive transmission apparatus as claimed in claim 1, wherein said means for rotating said spindles comprises a spindle drive gear fast with each spindle and a gear train for rotating said spindle drive gears during ratio changing.

3. Drive transmission apparatus as claimed in claim 2, wherein the gear train comprises a pair of bevel gears with which said spindle drive gears are in mesh, the spindle drive gears and bevel gears normally rotating as a unit and there being means for selectively retarding rotation of one or other of said bevel gears thereby to cause said spindle drive gears and the retarded bevel gear to rotate with respect to one another.

4. Drive transmission apparatus as claimed in claim 3, wherein each spindle drive gear has fewer teeth than the bevel gears whereby one rotation of the bevel gear causes more than one rotation of each spindle drive gear.

5. Drive transmission apparatus as claimed in claim 1, 2, 3 or 4, wherein said flexible element is a chain or toothed belt and each of said drive elements is a toothed cog, there being a one way clutch between each cog and the respective mounting element.

6. Drive transmission apparatus as claimed in any one of claims 2 to 5, wherein each mounting element is replaced by a pair of parallel spindles, the drive transmission element carried by each mounting element being mounted on it midway between said spindles.

7. Drive transmission apparatus as claimed in claim 1, wherein each of the threaded spindles has, at its radially inner end, a first gear wheel, the first rotatable member further comprising a pair of second gear wheels, the second gear wheels being arranged on opposite sides of the first rotatable element and each of the second gear wheels meshing with each of the first gear wheels, means being provided for selectively retarding rotation of either the one or the other said second gear wheels with respect to the first rotatable member.
